(19) United States
(12) Patent Application Publication
(10) Pub. No.: US 2020/0296334 A1
(43) Pub. Date: Sep. 17, 2020

(54) INFORMATION PROCESSING DEVICE AND AUTOMATIC TRAVELING CONTROL SYSTEM INCLUDING INFORMATION PROCESSING DEVICE

(71) Applicant: TOYOTA JIDOSHA KABUSHIKI KAISHA, Toyota-shi (JP)

(72) Inventor: Shin SAKURADA, Toyota-shi (JP)

(73) Assignee: TOYOTA JIDOSHA KABUSHIKI KAISHA, Toyota-shi (JP)

(21) Appl. No.: 16/800,538

(22) Filed: Feb. 25, 2020

(30) Foreign Application Priority Data
Mar. 13, 2019 (JP) 2019-045943

(51) Int. Cl. H04N 7/18; H04W 4/44

(52) U.S. Cl. CPC H04N 7/181; G05D 1/0088; H04W 4/44

(57) ABSTRACT

An information processing device includes: a reception portion configured to receive a signal transmitted from a wireless communication unit provided in a vehicle; a road travel environmental information generation portion configured to generate road travel environmental information including position information and time information of the vehicle based on the signal transmitted from the wireless communication unit; a failure determination portion configured to determine that the vehicle has a failure in a vehicle outside monitoring camera based on the signal from the wireless communication unit; and a transmission portion configured to transmit, to the vehicle determined to have the failure by the failure determination portion, image information outside the vehicle, the image information being necessary for driving and based on the road travel environmental information.

### INCORPORATION BY REFERENCE

The disclosure of Japanese Patent Application No. 2019-045943 filed on Mar. 13, 2019 including the specification, drawings and abstract is incorporated herein by reference in its entirety.

### BACKGROUND

### 1. Technical Field

The present disclosure relates to an information processing device and an automatic traveling control system including an information processing device.

### 2. Description of Related Art

In recent years, there has been known a self-driving vehicle that can autonomously travel even if a human does not perform some driving operations. The self-driving vehicle is equipped with vehicle outside monitoring cameras (hereinafter also just referred to as cameras) configured to capture images around the vehicle, for example. Such a technology is demanded that the self-driving vehicle travels safely even if communication failure or the like occurs due to breakdown or the like of some instruments in the self-driving vehicle.

Japanese Unexamined Patent Application Publication No. 2016-192028 (JP 2016-192028 A) discloses an automated driving control system configured such that, when a part of position estimation information cannot be acquired, the automated driving control system determines whether automated driving is performable or not based on a remaining part of the position estimation information that is acquired.

### SUMMARY

JP 2016-192028 A does not disclose a technology to continue automated driving when a camera provided in a self-driving vehicle has a failure during the automated driving. When a vehicle outside monitoring camera provided in the self-driving vehicle has a failure during the automated driving, this may affect a safe driving control and an automated driving control on the vehicle.

In view of this, an object of the present disclosure is to provide a technology to restrain influence on a safe driving control and an automated driving control on a vehicle when a vehicle outside monitoring camera provided in the vehicle has a failure.

An information processing device according one aspect of the present disclosure is an information processing device for transmitting, to a vehicle equipped with vehicle outside monitoring cameras, image information outside the vehicle, the image information being necessary for driving. The information processing device includes a reception portion, a generation portion, a failure determination portion, and a transmission portion. The reception portion is configured to receive a signal transmitted from a wireless communication unit provided in the vehicle. The generation portion is configured to generate road travel environmental information including position information and time information of the vehicle based on the signal transmitted from the wireless communication unit. The failure determination portion is configured to determine that the vehicle has a failure in any of the vehicle outside monitoring cameras based on the signal from the wireless communication unit. The transmission portion is configured to transmit, to the vehicle determined to have the failure by the failure determination portion, image information outside the vehicle, the image information being necessary for driving and based on the road travel environmental information.

With this aspect, when any of the vehicle outside monitoring cameras has a failure, it is possible to provide image information outside the vehicle that is necessary for driving to the vehicle having the failure in any of the vehicle outside monitoring cameras, based on road travel environmental information generated based on information from the wireless communication unit of the vehicle. Hereby, the vehicle having the failure in any of the vehicle outside monitoring cameras can continue driving, thereby making it possible to restrain notable influence on a safe driving control and an automated driving control on a self-driving vehicle as well as a vehicle driven by a driver.

With the present disclosure, it is possible to provide a technology to restrain influence on a safe driving control and an automated driving control on a vehicle when a vehicle outside monitoring camera with which a vehicle equipped has a failure.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of an information processing device and a plurality of vehicles communicable with the information processing device;

FIG. 2 is a block diagram illustrating a schematic hardware configuration of the information processing device;

FIG. 3 is a block diagram illustrating a schematic hardware configuration of the vehicle;

FIG. 4 is a view illustrating an example of a functional block configuration of the information processing device;

FIG. 5 is a flowchart illustrating an example of a processing procedure performed by the information processing device; and

FIG. 6 is a view to describe an exemplary operation when a vehicle outside monitoring camera provided in the vehicle has a failure.

### DETAILED DESCRIPTION OF EMBODIMENTS

With reference to the attached drawings, the following describes a preferred embodiment of the present disclosure. Note that, in each figure, members having the same reference sign have the same or similar configuration.

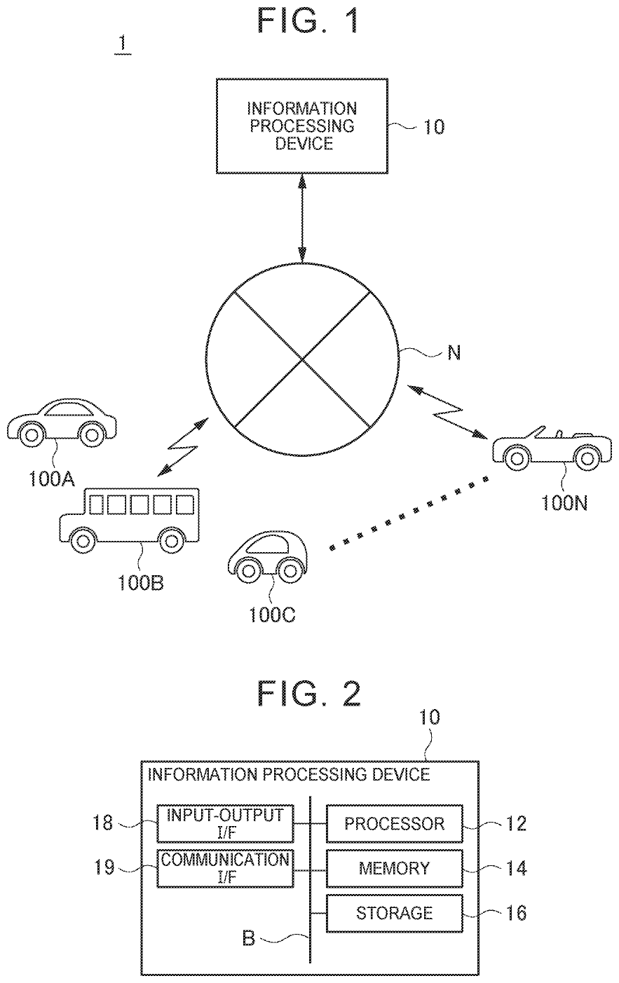

FIG. 1 illustrates an automatic traveling control system 1 including an information processing device 10 connected to a plurality of vehicles 100 via a network N. Note that, when a specific vehicle 100 is mentioned, it is referred to as a vehicle 100A, a vehicle 100B, or the like, and when a vehicle is generally mentioned, it is just referred to as the vehicle 100.

The communication network N illustrated in FIG. 1 may be, for example, any of the Internet, a LAN, a mobile communication network, Bluetooth (registered trademark), Wireless Fidelity (WiFi), other communication lines, combinations thereof, and so on. Note that at least a part of the information processing device 10 may be implemented by cloud computing constituted by one or more computers. In addition, at least some of processes in a control device 110 (described later) of the vehicle 100 may be executed by the information processing device 10.

FIG. 2 is a view illustrating an example of a hardware configuration of the information processing device 10 illustrated in FIG. 1. The information processing device 10 includes a processor 12, a memory 14, a storage 16, an input-output interface (input-output I/F) 18, and a communication interface (communication I/F) 19. Constituents of hardware (HW) of the information processing device 10 are connected to each other via a communications bus B, for example.

The information processing device 10 implements a function and/or a method described in the present embodiment in collaboration with the processor 12, the memory 14, the storage 16, the input-output I/F 18, and the communication I/F 19.

The processor 12 executes a function and/or a method implemented by a code or a command included in a program stored in the storage 16. The processor 12 includes, for example, a central processing unit (CPU), a micro processing unit (MPU), a GPU, a microprocessor, a processor core, a multiprocessor, an application-specific integrated circuit (ASIC), a field programmable gate array (FPGA), and so on.

The memory 14 is configured such that a program loaded from the storage 16 is temporarily stored in the memory 14, and the memory 14 provides a working area to the processor 12. Various pieces of data generated while the processor 12 executes a program are also temporarily stored in the memory 14. The memory 14 includes, for example, a random access memory (RAM), a read only memory (ROM), and so on.

A program and so on executed by the processor 12 are stored in the storage 16. The storage 16 includes, for example, a hard disk drive (HDD), a solid state drive (SSD), a flash memory, and so on.

The input-output I/F 18 includes an input device in which various operations to the information processing device 10 are input and an output device configured to output results of processes performed by the information processing device 10.

The communication I/F 19 transmits and receives various pieces of data via the network. The communication may be performed by wired communication or wireless communication, and any communication protocol may be used, provided that mutual communication can be performed. The communication I/F 19 has a function to perform communication with the vehicle 100 via the network. The communication I/F 19 transmits various pieces of data to other information processing devices and the vehicle 100 in accordance with instructions from the processor 12.

The program of the present embodiment may be provided in a state where the program is stored in a computer-readable storage medium. The storage medium can store the program in a “non-transitory tangible medium.” The program includes a software program and a computer program, for example.

At least some of processes in the information processing device 10 may be implemented by cloud computing constituted by one or more computers. At least some of the processes in the information processing device 10 may be performed by other information processing devices. In this case, at least some of processes of functional parts implemented by the processor 12 may be performed by other information processing devices.

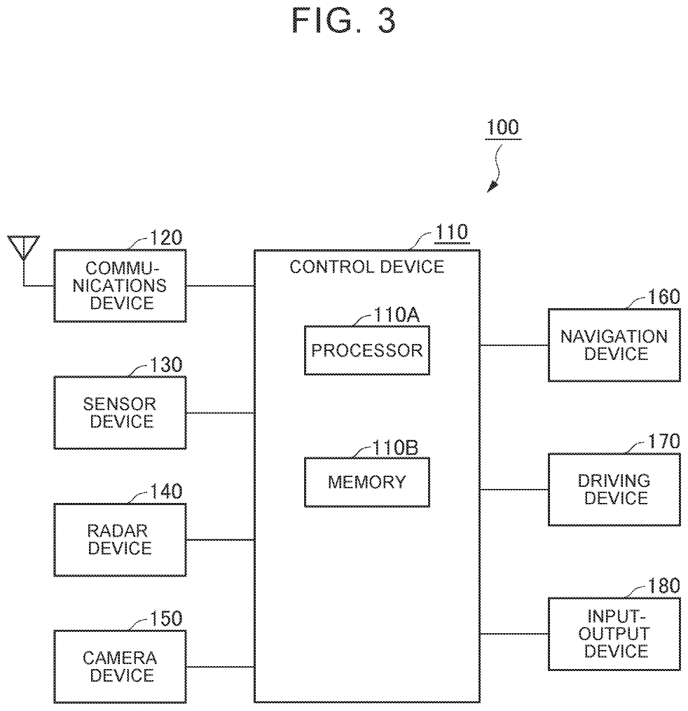

FIG. 3 is a block diagram illustrating a schematic hardware configuration of the vehicle 100.

As illustrated in FIG. 3, the vehicle 100 includes the control device 110, and a communications device 120, a sensor device 130, a radar device 140, a camera device 150, a navigation device 160, a driving device 170, and an input-output device 180 that are connected to the control device 110 via a bus or the like.

The control device 110 receives predetermined signals from the devices connected thereto, performs a computing process or the like, and outputs control signals to drive the devices. The control device 110 includes a processor 110A and a memory 110B.

The control device 110 can function as a driving support system according to the present embodiment by the processor 110A executing a computer program stored in the memory 110B.

The processor 110A executes a predetermined computing process in accordance with a computer program such as firmware stored in the memory 110B. The processor 110A is implemented by one or more central processing units (CPU), a micro processing unit (MPU), a GPU, a microprocessor, a processor core, a multiprocessor, an application-specific integrated circuit (ASIC), a field programmable gate array (FPGA), and so on.

The memory 110B includes a nonvolatile memory such as an MRAM, a NAND flash memory, a NOR flash memory, an SSD, or a hard disk drive, and a volatile memory such as an SRAM or a DRAM. In the nonvolatile memory, computer programs to execute various computing processes illustrated in the flowchart or the like in this disclosure, map data, and various other pieces of data necessary in this disclosure are stored. The nonvolatile memory corresponds to a non-transitory tangible medium. The volatile memory provides a working area in which a computer program loaded from the nonvolatile memory and various pieces of data generated while the processor 110A executes a computer program are temporarily stored. Note that a computer program or data acquired from the communications device 120 may be stored in the nonvolatile memory.

The communications device 120 includes a unit configured to transmit and receive information to and from an external device such as the information processing device 10 and includes one or more communication unit such as WiFi (a wireless communication method based on the 802.11 standard defined by IEEE), for example.

The external device may be other vehicles 100 or may be infrastructure equipment provided below a road surface or in a power pole, a building, or the like. Further, the communications device 120 receives a GPS signal and outputs position information of the vehicle 100 to the control device 110.

The sensor device 130 is a sensor configured to detect the behavior of the vehicle 100 and includes a rotary encoder configured to detect a vehicle speed of the vehicle and a gyro sensor configured to detect an inclination of the vehicle. Further, the sensor device 130 may include a magnetometric sensor or the like configured to detect a marker and others embedded in a road. The radar device 140 includes a LiDAR ranging system including a millimeter wave radar so as to avoid collision with a pedestrian or the like. The camera device 150 includes a plurality of cameras each including an imaging device such as a CCD or a CMOS image sensor so as to capture images ahead of the vehicle 100, on the right and left sides of the vehicle 100, and behind the vehicle 100 (images including surroundings of the vehicle 100). The control device 110 can receive signals acquired by the sensor device 130, the radar device 140, and the camera device 150 and output a control signal based on them to a device. For example, the control device 110 can acquire an imaging signal of an image captured by the camera device 150 and execute image recognition so as to recognize an obstacle or the like included in the image thus captured, and the control device 110 can accordingly output, to the driving device 170, a control signal to stop the vehicle 100, for example. Note that the camera device 150 may be equipped with a semiconductor IC for image processing such as GPU that enables image recognition or the like so that the camera device 150 recognizes a driving lane where the vehicle 100 should travel or an obstacle such as a pedestrian based on an image captured by a camera or the like of the camera device 150, and the camera device 150 may output information on the driving lane or the obstacle to the control device 110.

The navigation device 160 calculates a route to a predetermined destination based on an input from a driver or the like and performs guidance. The navigation device 160 may include a nonvolatile memory (not shown) and store map data in the nonvolatile memory. Alternatively, the navigation device 160 may acquire map data stored in the memory 110B or may acquire map data from the communications device 120. The map data includes information on road types and information about road signs, traffic lights, and so on. Further, the map data includes position information on a specific point called a node and indicative of a facility, an address, an intersection of a road, or the like, and information corresponding to a road called a link that connects nodes to each other. The position information is indicated by latitude, longitude, and altitude, for example.

Further, a processor for calculating a route may be provided in the navigation device 160, or the processor 110A may execute the calculation. Further, the navigation device 160 may be configured to acquire current position information of the vehicle 100 such that the navigation device 160 acquires, from the control device 110, position information acquired based on a GPS signal received by the communications device 120 or the navigation device 160 itself receives a GPS signal. Note that the navigation device 160 may be constituted by an information processing terminal owned by a driver or the like. In this case, the information processing terminal may be connected to an instrument or the like of the communications device 120 of the vehicle 100 so that route guidance information or the like to guide the route is output from the input-output device 180 of the vehicle 100.

The driving device 170 include motors and other actuators for operations of an engine, a brake, and a steering wheel of the vehicle 100 and operates based on a control signal received from the control device 110. Note that the vehicle 100 may be configured such that the control device outputs control signals to the driving device 170 and so on based on operations by the driver or the like on an accelerator pedal, a brake pedal, the steering wheel, and so on, but the vehicle 100 may have an automated driving function to output, from the control device 110 to the driving device 170 and so on, control signals to autonomously drive the vehicle 100 based on signals acquired from the radar device 140, the camera device 150, and so on. Further, the vehicle 100 may be an electric vehicle including a battery and an electric motor.

The input-output device 180 includes an input device such as a touch panel or a microphone via which the driver or the like inputs information into the vehicle 100, and sound recognition process software, and the input-output device 180 is configured to receive information necessary to control the vehicle 100 based on a pressing operation by the driver on the touch panel or an utterance made by the driver. Further, the input-output device 180 includes an output device such as a liquid crystal display, an HUD, or other displays configured to output image information and one or more speakers configured to output voice information.

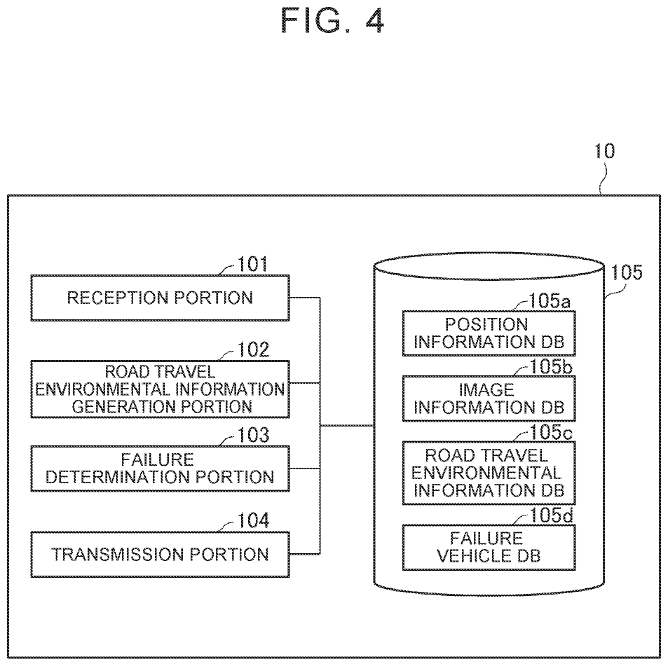

FIG. 4 is a view illustrating an example of a functional block configuration of the information processing device 10. The information processing device 10 includes a reception portion 101, a road travel environmental information generation portion 102, a failure determination portion 103, a transmission portion 104, and a storage portion 105.

The reception portion 101 receives a signal transmitted from a wireless communication unit provided in the vehicle 100. The reception portion 101 receives, for example, image information from the camera device 150, position information of the vehicle 100 that is transmitted via the communications device 120, and vehicle-speed and travel-direction information (cardinal direction information). The image information is information on images ahead of and behind the vehicle 100, including surroundings of the vehicle 100, and captured by the camera device 150. Those pieces of information received by the reception portion 101 are stored in a position information DB 105a and an image information DB 105b of the storage portion 105.

The road travel environmental information generation portion 102 generates road travel environmental information including position information and time information of the vehicle 100 based on a signal transmitted from the wireless communication unit provided in the vehicle 100. The road travel environmental information is stored in a road travel environmental information DB 105c of the storage portion 105. The road travel environmental information includes map information (regulation speeds, gradients, widths, presence or absent of traffic lights, and so on of roads, road types that are types of road classified by them (national road, express highway, open road, minor street passing through city area or the like, mountain road, and so on), and so on). The road travel environmental information also includes characteristics of roads where the vehicle 100 is planned to travel, traffic jam information of the roads, and so on.

Note that the following description deals with an example in which the road travel environmental information is generated based on a signal transmitted from the wireless communication unit provided in the vehicle 100. However, the road travel environmental information is not limited to this. For example, the road travel environmental information may be generated based on information collected from vehicles (surrounding vehicles) traveling around a vehicle in which the camera device 150 has a failure. The information thus collected includes, for example, pieces of image information from vehicle outside monitoring cameras provided in the surrounding vehicles, and pieces of position information, pieces of time information, and pieces of vehicle-speed and travel-direction information from the surrounding vehicles.

The failure determination portion 103 determines a broken-down vehicle in which the camera device 150 (a vehicle outside monitoring camera) has a failure based on a signal from the wireless communication unit of the vehicle 100. The broken-down vehicle thus determined to have a failure by the failure determination portion 103 is stored in a broken-down vehicle DB 105d of the storage portion 105. When the reception portion 101 does not receive at least one of pieces of image information (pieces of image information ahead of the vehicle 100, on the right and left side of the vehicle 100, and behind the vehicle 100) captured by the camera device 150, the failure determination portion 103 determines that the camera device 150 has a failure. In other words, when image information received by the information processing device 10 from the camera device 150 has an abnormality, the failure determination portion 103 determines that the camera device 150 has a failure. As described above, the vehicle 100 determined, by the failure determination portion 103, to have a failure in at least one of the cameras provided in the camera device 150 is referred to as a broken-down vehicle in the present specification.

The transmission portion 104 transmits control information necessary for driving based on road travel environmental information to the vehicle determined to have a failure by the failure determination portion 103. Note that the control information necessary for driving includes image information outside the vehicle, limited speed information in a particular area, positions of other vehicles, vehicle-speed and travel-direction information, road information, and other pieces of information, for example. Those pieces of information are stored in the storage portion 105. Also, the control information necessary for driving includes information necessary to control the vehicle such that the vehicle travels in an automated driving mode from a point where the vehicle breaks down to a safe area around the point.

Procedure of Process

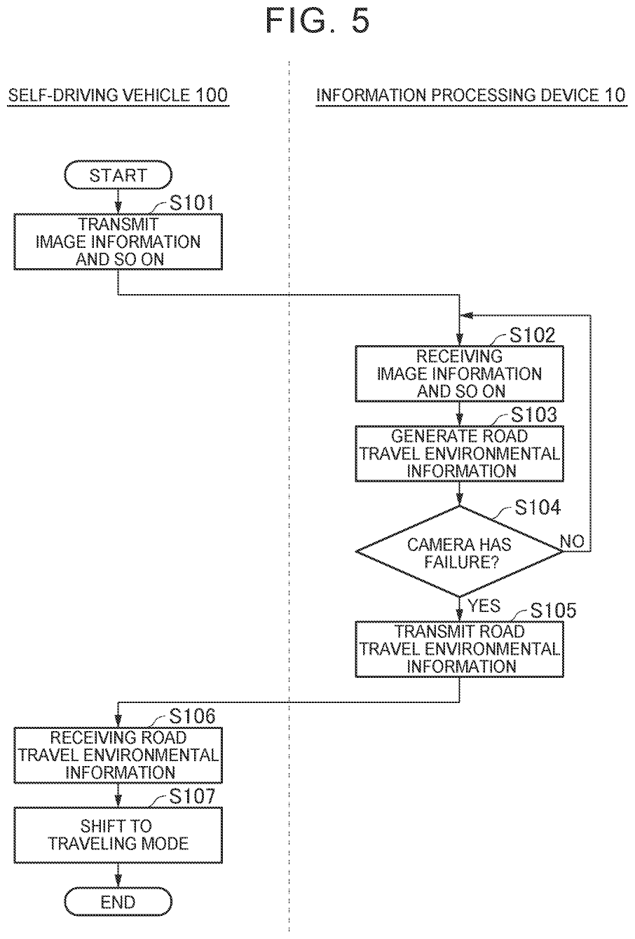

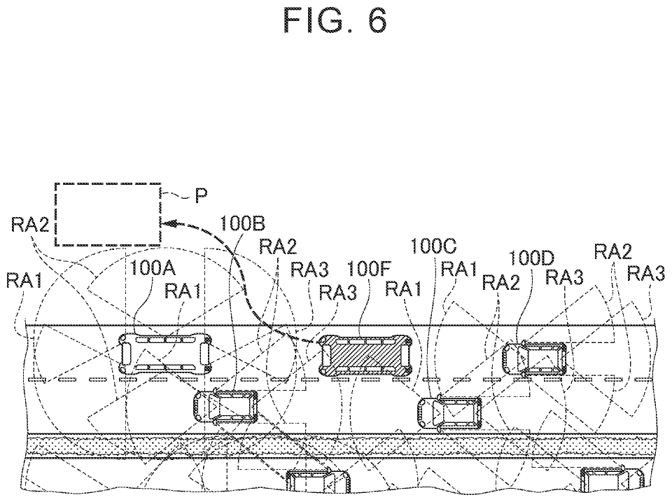

Next will be described a processing procedure performed by the information processing device 10. FIG. 5 is a flowchart illustrating an example of the processing procedure performed by the information processing device. FIG. 6 is a view to describe an exemplary operation when a camera has a failure.

In step S101, image information and so on, the image information being captured by the camera device 150 provided in the vehicle 100, is transmitted to the information processing device 10. The image information and so on include, for example, position information, time information, and vehicle-speed and travel-direction information (cardinal direction information) of the vehicle 100 that are transmitted via the communications device 120, in addition to pieces of image information around the vehicle 100 (ahead of the vehicle 100, on the right and left sides of the vehicle 100, and behind the vehicle 100), the pieces of image information being captured by the camera device 150. Note that the “image information and so on” in the present specification are not limited to these pieces of information and include information necessary to generate road travel environmental information as described below. FIG. 6 illustrates an example in which images in a range RA1 ahead of the vehicle 100A, ranges RA2 on lateral sides (the right and left sides) of the vehicle 100A, and a range RA3 behind the vehicle 100A are captured by the camera device 150 (not shown in FIG. 6) provided in the vehicle 100A. As described above, a signal transmitted from the wireless communication unit (the communications device 120) of the vehicle 100 includes pieces of image information from a plurality of vehicle outside monitoring cameras (the camera device 150) configured to capture images around the vehicle 100 during traveling. Further, the plurality of vehicle outside monitoring cameras provided in the vehicle 100 capture respective images ahead of, behind, and on the right and left sides of the vehicle 100 during traveling, as illustrated in FIG. 6.

In step S102, the information processing device 10 receives the image information and so on transmitted from the vehicle 100 during traveling.

In step S103, based on the image information and so on thus received, the information processing device 10 generates road travel environmental information on which information including the position information, the time information, and the vehicle-speed and travel-direction information of the vehicle 100 during traveling is reflected.

In step S104, based on a signal from the wireless communication unit provided in the vehicle 100, the failure determination portion 103 determines whether the camera device 150 provided in the vehicle 100 has a failure or not. When the reception portion 101 does not receive at least one of the pieces of image information ahead of, on the right and left sides of, and behind the vehicle 100, the pieces of image information being captured by the camera device 150, the failure determination portion 103 determines that the camera device 150 has a failure. When the failure determination portion 103 determines that the camera device 150 does not have a failure (step S104 (NO)), the process returns to step S102, and the aforementioned steps are repeated. When the failure determination portion 103 determines that the camera device 150 has a failure (step S104 (YES)), the process proceeds to step S105.

In step S105, the transmission portion 104 transmits control information (e.g., image information outside the vehicle and other pieces of information that are necessary for driving) necessary for automated driving to a broken-down vehicle 100 (a broken-down vehicle) thus determined, by the failure determination portion 103, to have a failure. The control information is based on the road travel environmental information generated by the road travel environmental information generation portion 102. Note that the transmission portion 104 transmits information including pieces of position information, time information, and vehicle-speed and travel-direction information (cardinal direction information) of vehicles (surrounding vehicles) traveling around the vehicle 100 determined to have a failure in the camera device 150.

In step S106, the vehicle 100 (the broken-down vehicle) receives the control information necessary for automated driving, the control information being transmitted from the transmission portion 104 of the information processing device 10.

In step S107, the vehicle 100 that has received the control information necessary for automated driving shifts to a traveling mode different from a current traveling mode. The traveling mode may be a traveling mode (an evacuation traveling mode) to evacuate the vehicle 100 to a neighboring safe location (e.g., a region P illustrated in FIG. 6) or may be a stop mode to stop the vehicle 100. Note that the present embodiment is not limited to the evacuation traveling mode or the stop mode. For example, a traveling mode (a failure traveling mode) at the time when the camera device 150 has a failure may be set in advance, and the vehicle 100 may be set to a mode to control the vehicle 100 such that the vehicle 100 travels in an automated driving mode or may be set to other automatic traveling modes, so as to correspond to the failure traveling mode.

In the embodiment described above, the transmission portion 104 may transmit the control information by changing an information amount of the control information (e.g., image information outside the vehicle and other pieces of information that are necessary for driving) in accordance with traveling speeds of surrounding vehicles that are traveling around a self-driving vehicle determined to have a failure in a vehicle outside monitoring camera.

The embodiment described above is intended to facilitate understanding of the present disclosure and is not intended to be construed as limiting the disclosure. The embodiment described above deals with an example of an automatic traveling control system including an information processing device and a self-driving vehicle configured to receive travel control information (e.g., image information outside the vehicle and other pieces of information) provided from the information processing device and shift to an automated driving mode based on the travel control information. However, the self-driving vehicle may have each function of the information processing device, or the self-driving vehicle may perform at least some of the processes of the functional parts implemented by the information processing device described above, for example. Further, the embodiment described above deals with an example in which the vehicle 100 is a self-driving vehicle. However, the embodiment is not limited to this example, and the vehicle in the present embodiment also includes a vehicle (for example, general vehicles and so on) other than the self-driving vehicle. The flowcharts and sequences described in the embodiment and each element provided in the embodiment and its arrangement, material, condition, shape, size, and the like are not limited to those described herein and can be changed appropriately. Further, the configurations described in different embodiments can be partially replaced or combined.

What is claimed is:

1. An information processing device for transmitting, to a vehicle equipped with vehicle outside monitoring cameras, image information outside the vehicle, the image information being necessary for driving, the information processing device comprising:
a reception portion configured to receive a signal transmitted from a wireless communication unit provided in the vehicle;
a generation portion configured to generate road travel environmental information including position information and time information of the vehicle based on the signal transmitted from the wireless communication unit;
a failure determination portion configured to determine that the vehicle has a failure in any of the vehicle outside monitoring cameras based on the signal from the wireless communication unit; and
a transmission portion configured to transmit, to the vehicle determined to have the failure by the failure determination portion, image information outside the vehicle, the image information being necessary for driving and based on the road travel environmental information.

2. The information processing device according to claim 1, wherein the signal transmitted from the wireless communication unit includes pieces of image information around the vehicle during traveling, the pieces of image information being captured by the vehicle outside monitoring cameras.

3. The information processing device according to claim 1, wherein each of the vehicle outside monitoring cameras captures a corresponding one of images ahead of and behind the vehicle during traveling and images on right and left sides of the vehicle during traveling.

4. The information processing device according to claim 1, wherein, when the reception portion does not receive any one of pieces of image information ahead of and behind the vehicle and on right and left sides of the vehicle, the pieces of image information being captured by the vehicle outside monitoring cameras, the failure determination portion determines that a corresponding one of the vehicle outside monitoring cameras has the failure.

5. The information processing device according to claim 1, wherein the transmission portion transmits information including position information of a surrounding vehicle traveling around the vehicle determined to have the failure in any of the vehicle outside monitoring cameras.

6. The information processing device according to claim 1, wherein the transmission portion transmits the image information by changing an information amount of the image information in accordance with a traveling speed of a surrounding vehicle traveling around the vehicle determined to have the failure in any of the vehicle outside monitoring cameras.

7. The information processing device according to claim 1, wherein the vehicle that has received the image information from the transmission portion shifts to an evacuation traveling mode or a stop mode.

8. An automatic traveling control system comprising:
the information processing device according to claim 1; and
a self-driving vehicle configured to receive the image information provided from the information processing device and shift to an automated driving mode based on the image information.
